(19) United States
(12) Patent Application Publication
(10) Pub. No.: US 2008/0282343 A1
(43) Pub. Date: Nov. 13, 2008

(54) Digital Rights Management Using Biometric Data

(75) Inventors: Geert Jan Schrijen, Eindhoven (NL); Thomas Andreas Maria Kevenaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,875

(22) PCT Filed: Nov. 7, 2006
(86) PCT No.: PCT/IB06/54144

§ 371 Date: May 7, 2008

(30) Foreign Application Priority Data
Nov. 9, 2005 (EP) 05110525.2

(51) Int. Cl. H04L 9/32

(52) U.S. Cl. 726/18

(57) ABSTRACT

Present inventions relates to a method of digital rights management for content data, comprising the steps of: obtaining (102) at least one bio metric measurement data, modifying (106) the biometric measurement data by using a transformation scheme, and associating (108) the modified biometric measurement data with the content data.

The present invention relates to a method of digital rights management (DRM) for content data. More particularly the invention relates to a computer program and a DRM system for performing the method.

Privacy and security are becoming more important as trade over the Internet and world-wide-web is constantly increasing. In addition new services are developed posing further challenges, in particularly for areas where only a rightful user shall be able to access information or content data. Businesses, authorities, healthcare organizations as well as consumers rely on systems and methods designed to provide security as well as privacy for the individual, and it is vital that these systems are relied upon. Often information/content data is transferred via Internet or a network, and the content data may be intercepted and tampered with to create mischief. Furthermore, if a content provider has delivered content data, it should be assured that the content is used as agreed upon when the delivery was ordered.

Today, for example, several online music stores are employing DRM to restrict the usage of music purchased online. The music is paid for and downloaded as an audio file, and the file has associated restrictions determined by the applied DRM system. For example, the music may be burned to a limited number of CDs, may only be copied ten times, may only be copied to four computers, may only be played in a specific software environment etc., or the user may not edit or sample the purchased music. Other similar DRM applications involve a user paying a subscription fee to a music store for access to download and use music content, but as soon as the user misses a payment, the downloaded music files are all made unusable since valid online subscription data must continuously be downloaded and incorporated with the content data.

A problem with DRM for audio files is that several programs for removing the DRM restrictions exist, which programs often are readily downloadable from the Internet. Without the DRM restrictions an audio file may be widely spread and used in a huge number environments, thereby denying a music store or an artist their rightful compensation for their service and work.

On the other hand, a person rightfully paying for an audio file may be restricted to play the music only on a specific device. So far consumers have not really accepted DRM and the issue is becoming increasingly controversial.

The above examples of music stores represent only one DRM application area, but the same applies for other applications where use of content data shall be restricted to its rightful user or owner. Examples of digital content are computer programs including computer games, video files, picture files, electronic books and other electronic publications. Moreover, the digital content is used in association with a number of electronic devices, e.g. computers, media players, mobile phones etc.

To further elucidate the privacy problem, current DRM systems express user rights in so-called licenses which typically are implemented as digital certificates. Such a license generally contains an identifier of a user that has bought the content data, or an identifier of a device on which the license may be used. The identifier could be a name, a public key, an IP address, etc., and since the licenses are public, it results in the identifiers being visible to others. Different content items that are bought by the same person, or via the same device, can therefore be linked, and this may harm the user's privacy.

It is an object of the present invention to provide improved digital rights management that mitigates the problems with prior art as discussed above, for example associating content data with a rightful user, making removal of DRM restrictions from content data at least substantially harder, and facilitating rightful user access to content data, while still obtaining user privacy and security.

The object is achieved in one aspect by providing a method of digital rights management for content data, comprising the steps of:
obtaining at least one biometric measurement data,
modifying the biometric measurement data by using a transformation scheme, and
associating the modified biometric measurement data with the content data.

The method according to the invention is highly advantageous since the content data is associated with biometric measurement data, meaning that the content data is associated with at least one physical person. Since this association is present, the content data must not longer be restricted for use in a limited number of devices, and/or content data must not longer involve regular updates for proper functionality, e.g. when a user obtains a new device on which he wants to render his content. Furthermore, privacy is protected since the biometric measurement data is modified by a transformation scheme, making it unlinkable, or at least very hard to link, to the person from which the biometric data was originally derived. It should be noted that unrightful removal of DRM restrictions is also made harder, since a malicious user would indeed strive to remove not only the association between biometrics and content data, but also the biometric measurement data itself, even if the biometric measurement is modified according to the method of the invention.

The step of modifying the biometric measurement data may be preceded by the step of generating the transformation scheme used for modifying the biometric measurement data, and the transformation scheme may differently modify the biometric measurement data each time the method is performed. Furthermore, the transformation scheme may be unique, and the generation of the transformation scheme may involve the use of random data.

This is advantageous since it assures, because the modification of the biometric measurement data depends on the transformation scheme, that privacy is maintained for the owner of the biometric data. This of course also means that the modified biometric measurement data will be different each time the method is carried out, even if the same biometric measurement data was originally obtained. Without knowledge of the original biometric measurement data, the different modified biometric measurement data cannot be linked to each other, and this benefits the user's privacy.

The step of associating the modified biometric measurement data with content data may also involve embedding the modified biometric measurement data and the content data in a license. Moreover, the license may be a user right or a digital certificate.

By embedding biometric data and content data in license, it is substantially harder to separate the biometrics from the content without corrupting the content data, making unauthorized tampering with the content much less attractive.

The content data may consist of, for example, a software program, video file, audio file, picture file or an electronic book or document, but may of course be any data content representing a value and where unauthorized access should be prevented, such as electronic (medical) health records, and logos and ringtones on mobile phones.

Moreover, the biometric measurement data may refer to one person, but may also refer to multiple persons.

By referring multiple biometric measurement data to the same person, tampering with the content right is made harder and the probability of successful and correct identification of a person in later stages, may increase. An advantage with biometric measurement data referring to multiple persons is the possibility to obtain content access for a group of persons, such as a family purchasing a film having the form of a video file.

The biometric measurement data may also be associated with at least one further identifier. Furthermore a first biometric measurement data of a first person may be associated with at least one further identifier, and a second biometric measurement data of a second person may be associated with at least one further identifier.

By applying a further identifier a more versatile identification of a person is possible. Moreover, it facilitates for the license issuer to create a license. The license provider may simply use the further identifier and does not have to manage the biometric part, and this makes the system more flexible and allows for, for example, convenient market introductions.

The further identifier may be a user identifier or a device identifier or a combination thereof. In a preferred version the further identifier is a public key, and the association between the biometric measurement data and the further identifier may be protected by a digital certificate.

This allows original biometric measurement data belonging to a specific person to be encrypted and safely used in connection with the content data. Also, when used in connection with the transformation scheme, the further identifier may facilitate the modification of the original biometric so that the modification can not be linked to, or be used for deriving, the original biometrics.

The biometric measurement data may be obtained by a server from a client, and the steps of modifying the biometric measurement data and associating the modified biometric measurement data with the content data, may be performed on the server.

Furthermore, the steps of obtaining the biometric measurement data and modifying the biometric measurement data may be performed on a client, and associating the modified biometric measurement data with the content data may be performed on a server communicating with the client.

Preferably the client-server communication is performed via a secure authenticated channel.

The steps according to the method of the invention may also be followed by the step of sending the modified biometric measurement data and the content data as a data package, from a server to a client.

The client-server relationships and communication above further facilitates efficient and secure transfer of data while assuring privacy, and typically also involves secure online content purchase. It also provides additional privacy for the person to which the biometric measurement data belongs to.

According to another aspect of the invention, a computer program is provided comprising software instructions capable of performing the method according to the invention.

According to still another aspect of the invention, a DRM system for associating biometric measurement data with content data is provided, comprising means for performing a method according to the invention.

The computer program and the DRM system according to the invention both have the same advantages as the earlier discussed method according to the invention. All various features discussed for the method may also be implemented for the computer program and the DRM system according to the invention.

Embodiments of the present invention will now be described, by way of example, with reference to the accompanying schematic drawing, in which:

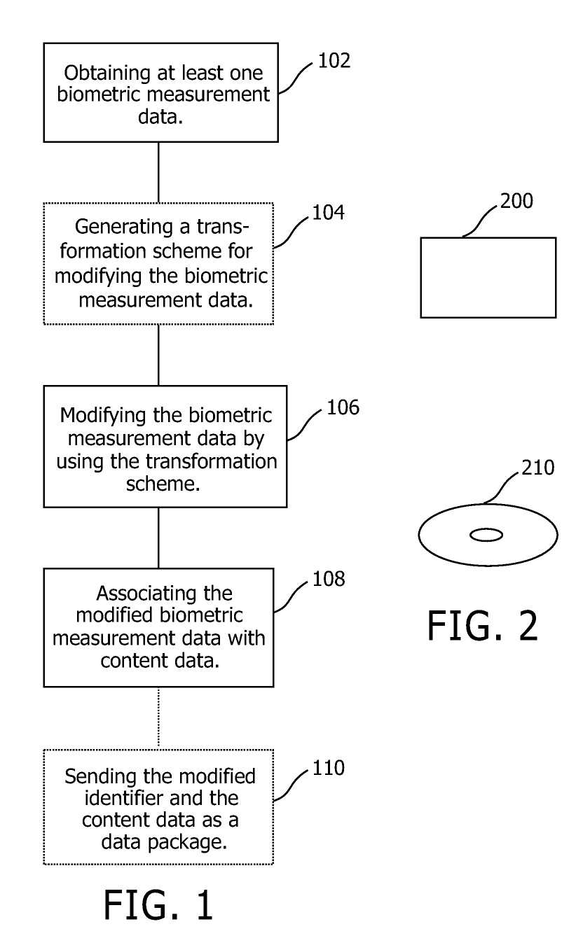

FIG. 1 is a diagram of the method of digital rights management for content data, and

FIG. 2 illustrates a system and computer program product.

A method of digital rights management for content data will now be described. It should be noted, however, that no detailed description will be made of the DRM system as such. It is also to be noted that no detailed description will be made of content data, the biometric measurement data or methods for creating the biometric data per se, as it would depend on the specific type of content data and biometric data to be used according to the invention, as the skilled person will understand.

Referring to FIG. 2, computer program code implementing a method according to the invention, with or without program code of other functions of the DRM system 200, may reside on any memory 210 for digital storage and may also be considered as a form of transmitted signal, such as a stream of data communicated via any type of communication network.

Turning now to FIG. 1 illustrating the method according to the invention, preferably a client obtains 102 at least one biometric measurement data from a user, either directly by means of a biometric reader communicating with the client and reading the user's biometrics, or by means of a smartcard having the biometrics already stored. The local device then generates 104 a transformation scheme for modifying the biometric measurement data. Preferably random data is involved for rendering a unique transformation scheme. After this the local device modifies 106 the biometric measurement data by using the transformation scheme, making it virtually impossible to link the original biometrics with the modified biometrics if the random data is not known. How the biometrics are modified depends on the type of applied biometrics, and any suitable method for data modification or encryption may be applied.

Preferably a secure and authenticated channel is established between the client and a server providing the content data, before the modified data is sent to the server for associating 108 the modified biometric measurement data with the content data residing on the server. Once the association 108 is performed, the modified biometric measurement data and the content data, now preferably embedded in a digital license having the form of a user right or a digital certificate, are sent 110 from the server to the client.

Once the license is present at the user and the content data shall be accessed, the user verifies his access rights to the content by providing the client, or any other device were the license is present, with his/her original biometric measurement data. The verification process can be done by any suitable method of verification.

Typically the method according to the invention also involves online purchase were communication is done over the Internet, and the biometric measurement data may be, for example, any of a fingerprint, vocal pattern, handwriting pattern, facial feature, hand geometry or an eye characteristic.

The content data may be any type of data were the right to access should be restricted.

The transformation scheme could, for example, be a so called helper data scheme (HDS). In HDSs a mapping (W,S)=F_{G}(X) is defined, where X is the biometric measurement data, W is helper data and S enrollment data. The HDS also defines a second mapping G when a noisy version Y of the original biometrics X is given, such that S′=G(Y,W), where S′ is the verification data. If the noise on Y is not too high, S and S′ will be equal with high probability. Thus, the mapping G is a noise-robust transformation of Y using the helper-data W. Note that F_{G} can be a randomized transformation and that for one X, several values of W and S can be derived that all refer to the same biometric.

In this approach the public identifier is the tuple (W,S). During identification/authentication, S′ is determined according to S′=G(Y,W) and compared with S stored during enrolment. Depending on the outcome, the DRM systems grants the user access to content.

The transformation scheme could also, for example, be a part of the inherent nature of a probabilistic function or a Monte Carlo method. This means that, for example, the probabilistic function itself is not the transformation scheme, but it generates a transformation scheme by its nature, which scheme modifies the biometric measurement data.

In order to further describe an embodiment of the invention, when content is purchased online, a user interacts, via a local device, with a server from the content provider. For authentication purpose the user uses a smart card at the local device. Via an authentication protocol, the local device verifies the presence of the user's smart card to identify the user, which smart card contains a private key of the user. Similarly, via an online authentication protocol the server from the content provider can check that the user's smart card is present. Furthermore the local device can set up a secure authenticated channel (SAC) with the server. During this SAC procedure the server can check whether the local device is compliant, and should abort the procedure if this is not the case. After the user has selected the desired content and possibly has initiated a payment transaction, the content provider creates an appropriate user right. This user right should contain an identifier of the person who bought the content, and embedment of the user's public key in the license is done. Note that the server checked the public key in the authentication phase earlier described.

To obtain a trustworthy biometric identifier for embedding in the user right, when there is not yet an association between the user's public key and some biometric identifier, an appropriate identifier is created by the local device.

The local device has biometric measurement capabilities and the local device performs an enrolment measurement of the user. Then the local device chooses a random secret S (enrolment data) and appropriate helper data W. Although in principle W depends on S, there usually is some freedom in selecting the reliable components that are part of W such that the biometric identifier (S, VV) will be unlinkable from any previously biometric identifiers for the same user. After having established a robust and unlinkable biometric identifier, the local device sends it via the SAC to the server of the content provider. The server then embeds the retrieved biometric identifier in the user right. Note that the server trusts the correctness of the retrieved identifier since the local device is compliant, which was checked when the SAC was set up.

1. A method of digital rights management for content data, comprising:
obtaining at least one biometric measurement data,
modifying the biometric measurement data by using a transformation scheme, and
associating the modified biometric measurement data with the content data.

2. The method of claim 1, wherein modifying the biometric measurement data is preceded by generating the transformation scheme used for modifying the biometric measurement data.

3. The method of claim 1, wherein the transformation scheme differently modifies the biometric measurement data each time the method is performed.

4. The method of claim 1, wherein the transformation scheme is unique.

5. The method of claim 1, wherein the generation of the transformation scheme includes using random data.

6. The method of claim 1, wherein associating the modified biometric measurement data with content data includes embedding the modified biometric measurement data and the content data in a license.

7. The method of claim 6, wherein the license is one of a user right and a digital certificate.

8. The method of claim 1, wherein the content data is one of a software program, video file, audio file, picture file and an electronic book.

9. The method of claim 1, wherein the biometric measurement data refers to one person.

10. The method claim 1, wherein the biometric measurement data refers to multiple persons.

11. The method of claim 1, wherein the biometric measurement data is associated with at least one further identifier.

12. The method of claim 1, wherein a first biometric measurement data of a first person is associated with at least one further identifier, and a second biometric measurement data of a second person is associated with at least one further identifier.

13. The method of claim 11, wherein the further identifier is one of a user identifier and a device identifier.

14. The method of claim 11, wherein the association between the biometric measurement data and the further identifier is protected by a digital certificate.

15. A computer readable medium, having a computer program embedded therein, including software instructions for performing digital rights management for content data comprising:
obtaining at least one biometric measurement data;
modifying the biometric measurement data by using a transformation scheme; and
associating the modified biometric measurement data with the content data.

16. A DRM system in which biometric measurement data is associated with content data, comprising:
means for obtaining at least one biometric measurement data;
means for modifying the biometric measurement data by using a transformation scheme; and
means for associating the modified biometric measurement data with the content data.
